(19) United States
(12) Patent Application Publication
(10) Pub. No.: US 2010/0302994 A1
(43) Pub. Date: Dec. 2, 2010

(54) CHANNEL SWITCHING IN A COMMUNICATION NETWORK

(75) Inventors: Christos Tachtatzis, Glasgow (GB); Florence Touvee, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI Scotland Limited, Glasgow (GB)

(21) Appl. No.: 12/678,138

(22) PCT Filed: Sep. 15, 2008
(86) PCT No.: PCT/GB08/03116

§ 371 Date: Jun. 8, 2010

(30) Foreign Application Priority Data
Sep. 13, 2007 (GB) 0717898.1

(51) Int. Cl. H04J 3/08; H04W 8/00

(52) U.S. Cl. 370/315; 370/329

(57) ABSTRACT

There is provided a method of changing channels in a communication network, there being a traffic flow on a first channel between first and second devices in the network, the method comprising forming an information element, the information element including a channel change request from the first device; and transmitting the information element from the first device to the second device in a Beacon frame.

### TECHNICAL FIELD OF THE INVENTION

The invention relates to switching channels in a network, and in particular relates to a method and apparatus for switching channels in an ultra wideband network.

### BACKGROUND TO THE INVENTION

Ultra-wideband is a radio technology that transmits digital data across a very wide frequency range, 3.1 to 10.6 GHz. By spreading the RF energy across a large bandwidth, the transmitted signal is virtually undetectable by traditional frequency selective RF technologies. However, the low transmission power limits the communication distances to typically less than 10 to 15 meters.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 10-15 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312.5 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

A sequence of three frequencies on which each data symbol is sent represents a Time Frequency Code (TFC) channel. A first TFC channel can follow the sequence 1, 2, 3, 1, 2, 3 where 1 is the first sub-band, 2 is the second sub-band and 3 is the third sub-band. Second and third TFC channels can follow the sequences 1, 3, 2, 1, 3, 2 and 1, 1, 2, 2, 3, 3 respectively. In accordance with the ECMA-368 specification, seven TFC channels are defined for each of the first four band groups, with two TFC channels being defined for the fifth band group. The sequences for each of the TFC channels in the five band groups are shown in FIGS. 2(a)-(e).

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

In wireless networks such as UWB networks, one or more devices periodically transmit a Beacon frame during a Beacon Period. The main purpose of the Beacon frame is to provide for a timing structure on the medium, i.e. the division of time into so-called superframes, and to allow the devices of the network to synchronize with their neighbouring devices.

The basic timing structure of a UWB system is a superframe as shown in FIG. 3. A superframe according to the European Computer Manufacturers Association standard (ECMA), ECMA-368 2^{nd} Edition, consists of 256 medium access slots (MAS), where each MAS has a defined duration e.g. 256 μs. Each superframe starts with a Beacon Period, which lasts one or more contiguous MAS's, during which devices can transmit their Beacon frames. The start of the first MAS in the Beacon Period is known as the Beacon Period Start Time (BPST). A Beacon group for a particular device is defined as the group of devices that have a shared Beacon Period Start Time (±1 μs) with the particular device, and which are in transmission range of the particular device.

In ECMA-368, data transmissions from communicating devices are carried in an explicit group of Medium Access Slots (MAS) over a single assigned time frequency code (TFC) channel. The mapping between devices and the MAS to be used (i.e. the indications of which device pairs will be communicating and in which Medium Access Slot(s)) is communicated by each device in the Beacon Period at the start of each superframe. Devices may also exchange data in unreserved MASs if the MASs are not Hard DRP reserved, or if Hard DRP or private reserved MASs are relinquished.

According to the current ECMA-368 standard, individual devices join an appropriate TFC channel and transmit/receive accordingly on this single channel until it is instructed or decides otherwise. A change in the TFC channel used by a device or devices is managed by a higher layer, and requires the completion of the current superframe.

A device in an ultra wideband network may decide to change channel if the link quality is poor and/or reducing, if the channel occupancy is high and/or increasing, if the current channel does not satisfy their communication demands and that the problems may be resolved by changing the operating channel of the device.

However, communication flows attached to the device (i.e. terminated at or originating from the device) will be disrupted.

The existing ECMA-368 standard provides the capability for a device to advertise when it will switch channel, in terms of the number of superframes after the current superframe, but only to its neighbouring devices (i.e. those devices with which it communicates directly) and does not detail how the value of the Channel Change Countdown (CCC), used to advertise when the channel switch will occur, should be calculated. The channel switching operation is intended to allow devices to satisfy their quality of service (QoS) requirements by redistributing traffic flows onto a different channel.

In addition, where a device is transmitting information to, or receiving information from, a device that is not one of its neighbours (i.e. the device is communicating with another device that is more than one “hop” away), there is no mechanism in the standard to allow the device to change channel while maintaining the traffic flow connectivity.

There is therefore a need for a method and apparatus that allows this type of communication to continue after a channel change operation has been completed.

### SUMMARY OF THE INVENTION

According to a first aspect of the invention, there is provided a method of changing channels in a communication network, there being a traffic flow on a first channel between first and second devices in the network, the method comprising forming an information element, the information element including a channel change request from the first device; and transmitting the information element from the first device to the second device in a Beacon frame.

According to a second aspect of the invention, there is provided a first device for use in a communication network, the first device being adapted to maintain a traffic flow on a first channel with one or more other devices in the network, the first device comprising means for forming an information element, the information element including a channel change request and means for transmitting the information element from the first device to the one or more other devices in a Beacon frame.

### BRIEF DESCRIPTION OF THE DRAWINGS

The invention will now be described in detail, by way of example only, with reference to the following drawings, in which:

FIG. 1 shows the arrangement of frequency bands in a Multi-Band Orthogonal Frequency Division Multiplexing (MB-OFDM) system for ultra-wideband communication;

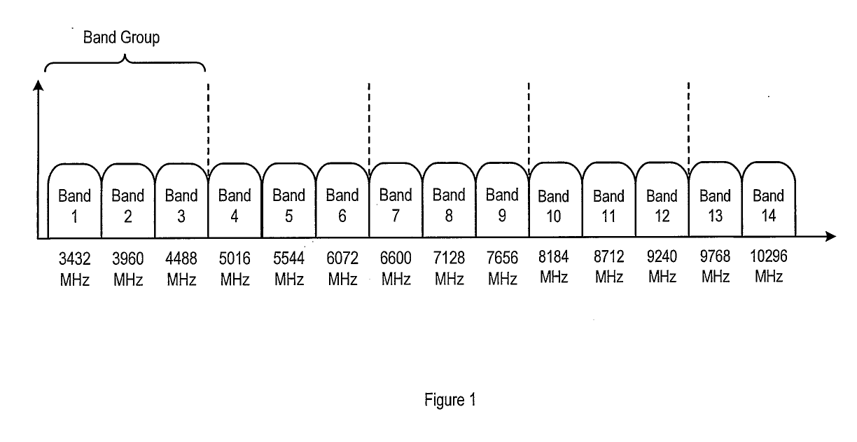

FIGS. 2(a)-(e) show the sequence definitions of the TFC channels in each of the five band groups;

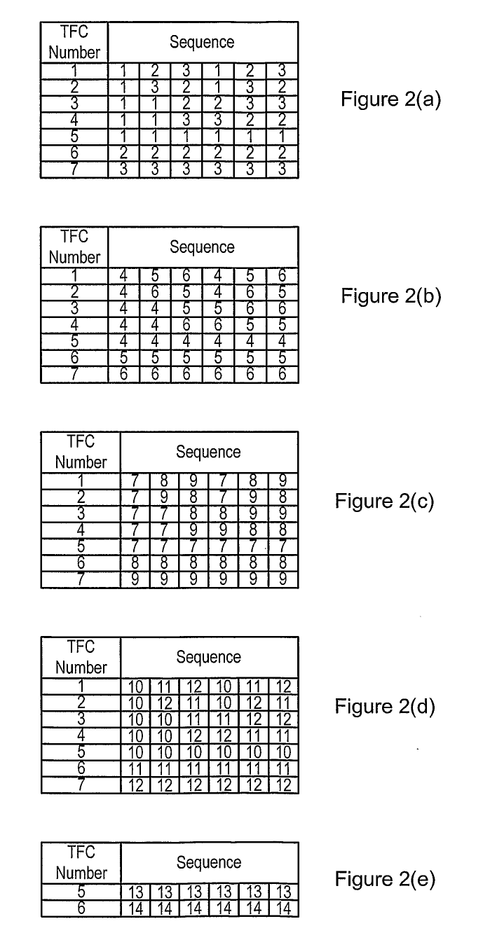

FIG. 3 shows the basic timing structure of a superframe in a UWB system;

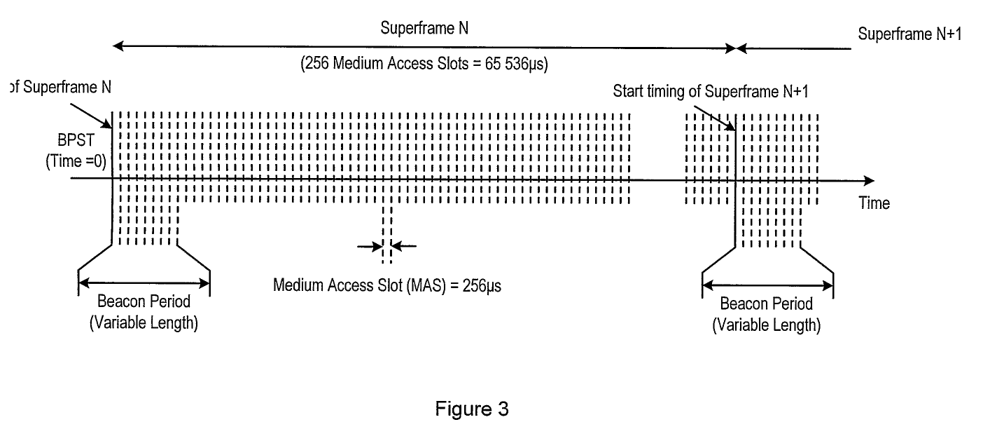

FIG. 4 shows an exemplary network in accordance with the invention;

FIG. 5 shows the structure of a Channel Change Occupancy Information Element (CCOIE) in accordance with an embodiment of the invention;

FIG. 6 is a flow chart illustrating the steps carried out by a channel switching instigating device in accordance with an aspect of the invention;

FIG. 7 shows a step of the method of FIG. 6 in more detail;

FIG. 8 is a flow chart illustrating the steps performed by the channel switching instigator in response to receiving a Beacon frame with a CCOIE element;

FIG. 9 is a flow chart illustrating the steps performed by a relay device after a Beacon frame with a CCOIE is received;

FIG. 10 is a flow chart illustrating the steps performed by a relay device in transmitting a Beacon frame after receiving a CCOIE from the channel switching instigator;

FIG. 11 is a flow chart illustrating the steps performed by a connected device after receiving a Beacon frame with a CCOIE;

FIG. 12 is a flow chart illustrating a step in the method of FIG. 11 in more detail;

FIG. 13 is a flow chart illustrating the steps in a method performed by the channel switching instigator in determining whether to switch channels; and

FIG. 14 shows the steps carried out by the channel switching instigator following a decision to realise the channel switch.

### DETAILED DESCRIPTION OF THE PREFERRED EMBODIMENTS

Although the invention will now be described with reference to an ultra wideband network, it will be appreciated that the invention is applicable to any other type of peer-to-peer network in which communications between devices can involve more than one “hop”.

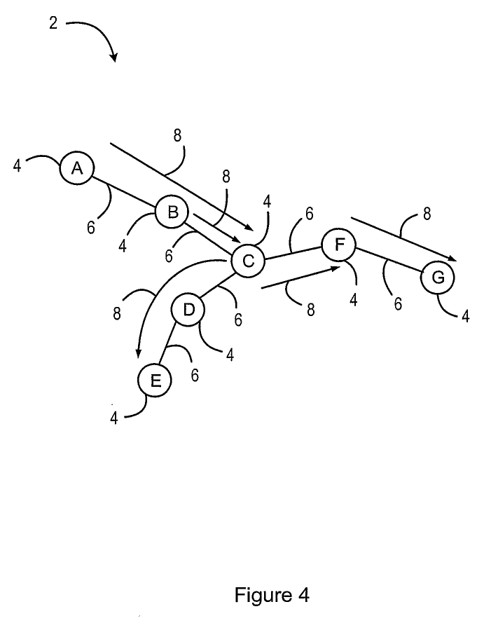

FIG. 4 shows an exemplary network 2 in accordance with the invention. The network 2 comprises seven devices 4, labelled A to G. The devices may be any suitable devices that are able to communicate using ultra wideband, such as a mobile phone, laptop, PDA, etc.

The lines 6 between the devices 4 represent physical communication links between the devices 4, while arrows 8 represent flows. A flow is defined as a connection between a pair of devices 4 that can traverse single or multiple “hops”. Thus, device A is transmitting a data flow to device C via device B, which has two “hops”, the first “hop” from device A to device B, and the second “hop” from device B to device C. Any device 4 may have incoming and/or outgoing flows attached to it. For example device C has four attached flows—device A to device C, device B to device C (both incoming flows), device C to device E and device C to device F (both outgoing flows).

“Connected devices” is used to describe the set of devices connected to a specific device via any attached flows. For example, device C's connected devices are devices A, B, E and F and the connected devices of device F are devices C and G.

The “channel switching instigator” is the device that triggers a channel switching procedure. In the example shown in FIG. 4, device C will be the channel switching instigator.

Devices that are in intermediate positions in a traffic flow are referred to as “relay” devices. There are two types of relay devices, those that act solely as relays and there are no flows that terminate at, or initiate from, these devices (such as device D in FIG. 4) and those that act as relays but have other connected devices (such as device B in FIG. 4). The latter devices are classified as relays due to their capacity to relay traffic, in addition to their independent flows.

The following description indicates how advertisement and coordination of the channel switching is carried out by the channel switching instigator. However, the following description does not set out the conditions or criteria that must be met for a channel switch operation to be initiated or how to select the actual channel to which the devices will switch. It will be appreciated that these procedures can be carried out in any suitable manner, including those as set out in the ECMA-368 standard.

In accordance with an aspect of the invention, when the channel switching procedure is triggered or instigated, the channel switching instigator communicates its intention to switch channel to all its connected devices through Beacon frames. The procedure comprises two phases. The first phase is the advertisement of the channel switching, and the second phase is the realisation of the channel switching itself. The operation of every device can be further divided into two sub-phases, the transmitted Beacon sub-phase, and the received Beacon sub-phase.

A high level view of the steps taken by the channel switching instigator is as follows. Once the channel switching procedure is triggered, the channel switching instigator includes channel switching information in its Beacon frame. Preferably, in an ultra wideband network, this channel switching information is contained in a Channel Change Occupancy Information Element (CCOIE) of the Beacon frame, which will be described further below. The channel switching information preferably includes a countdown element which is set to a value that is high enough to allow for the channel switching advertisement to propagate to the most distant devices (in terms of hops) in the network, and for responses to be returned to the channel switching instigator. Preferably, this countdown is in the form of a Channel Change Countdown (CCC) element in the CCOIE. In addition, the channel switching instigator preferably also includes a list of connected devices in the Beacon frame, so that the appropriate devices know that they are going to switch channel.

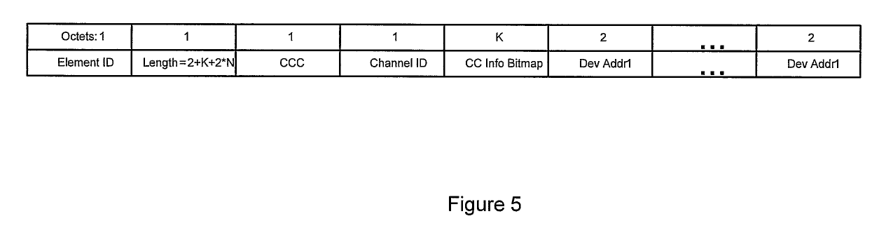

In order to facilitate the description of the invention with reference to an ultra wideband network, a Channel Change Occupancy Information Element (CCOIE) structure will now be described with reference to FIG. 5. However, it will be appreciated that when the invention is put into effect on other types of network, alternative information structures can be used in order to advertise and carry out the channel switch.

The Channel Change Occupancy Information Element (CCOIE) structure comprises a first octet which indicates the Element ID of the CCOIE; a second octet that indicates the length of the CCOIE (where the length is equal to 2+K+2N); a third octet that indicates the value of the Channel Change Countdown (CCC) element (which indicates the remaining number of superframes before a device moves to the new channel defined in the following Channel ID field); a fourth octet indicating the identity of the channel to which the devices will switch; K octets of 2-bit elements that indicate the channel change advertising state of each connected and relay device (CC Info Bitmap); and lastly two octets per connected and relay device indicating the addresses of those devices.

The values of the 2-bit elements in the Channel Change Information Map indicate the status of a particular connected or relay device after a channel switching request has been sent. In one embodiment, the value 00 indicates that the device has rejected the channel switching request; the value 01 indicates that the device has not yet responded to the channel switching request (i.e. the request is pending); the value 10 indicates that the device has responded to the channel switching request, but has requested an extension (i.e. the request is pending but extended); and the value 11 indicates that the device has accepted the channel switching request.

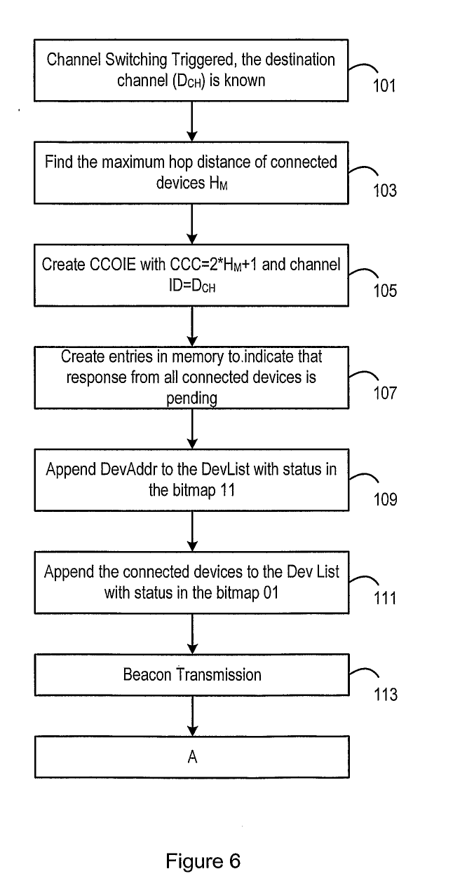

FIG. 6 is a flow chart illustrating the steps in the method of advertising the channel switch by the channel switching instigator in accordance with an aspect of the invention. In step 101, the channel switching instigator has determined or decided that it will switch channels to a destination channel (D_{ch}) in accordance with any suitable method, and therefore the channel switching advertisement procedure is started. The devices that are connected to, or relay devices for, the channel switching instigator are known.

Steps 103 to 111 illustrate the operations required by the channel switching instigator to generate an appropriate CCOIE. It will be appreciated that these steps do not have to be performed in the indicated order.

In step 103, the maximum hop distance of connected devices from the channel switching instigator H_{M} is determined. This information is provided by the routing layer, which is the layer above the MAC protocol.

In step 105, the channel switching instigator creates a Channel Change Occupancy Information Element (CCOIE) and preferably sets the Channel Change Countdown (CCC) octet to the value of 2*H_{M}+1 and the Channel ID octet to D_{ch}. This value of the CCC is selected as it is a sum of the number of hops to reach the most distant connected device plus the same number of hops back, plus 1, because the CCOIE will be sent in the next superframe.

In step 107, the channel switching instigator creates an entry in its memory for each of the connected and relay devices to indicate that a response to the channel switching request is pending (i.e. the entry can be 01 to correspond to the value used to denote a pending request in the CC Info Bitmap).

In step 109, the channel switching instigator appends its own address to the CCOIE with a corresponding status in the CC Info Bitmap of 11, indicating that it has accepted the channel switch request.

In step 111, the channel switching instigator appends the addresses of the connected and relay devices to the CCOIE and indicates their status in the CC Info Bitmap as 01, meaning that the channel switch request is pending.

In step 113, the channel switching instigator transmits the generated CCOIE in its Beacon frame, which is transmitted in the Beacon Period at the start of a superframe.

Thus, with the generated CCOIE, the channel switching instigator can coordinate the switch across multiple hops, since these devices are listed in the CCOIE, and can coordinate the timing of the channel switch using the CCC field.

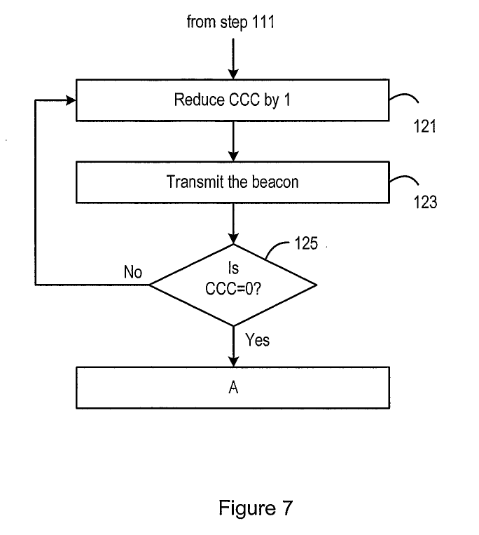

FIG. 7 shows step 113 of FIG. 6 in more detail. After step 111 of FIG. 6, the value of CCC in the CCOIE is decreased by one (step 121) and the CCOIE (updated with any changes to the CC Info Bitmap as appropriate) is transmitted in the next Beacon frame of the channel switching instigator (step 123). If CCC now equals 0 (step 125), the procedure moves to A, and the channel switching advertisement procedure is completed. If CCC does not equal 0, the method returns to step 121 in which CCC is decreased by one, and the CCOIE (updated with the new value of CCC and any changes to the CC Info Bitmap) is transmitted in the Beacon frame of the channel switching instigator in the Beacon Period of the next superframe.

Devices receiving Beacon frames with a CCOIE can be relay devices, connected devices or other devices in range of the channel switching instigator that are neither relay devices nor connected devices. In the case of devices that are neither relay devices nor connected devices, the devices ignore the CCOIE or act according to the ECMA standard. Alternatively, the CCOIE can be used and passed on to the higher layers to update the neighbour tables of each device (in other words, the CCOIE can be used by the routing layer to allow the device to know which devices will be present on a channel at a given time).

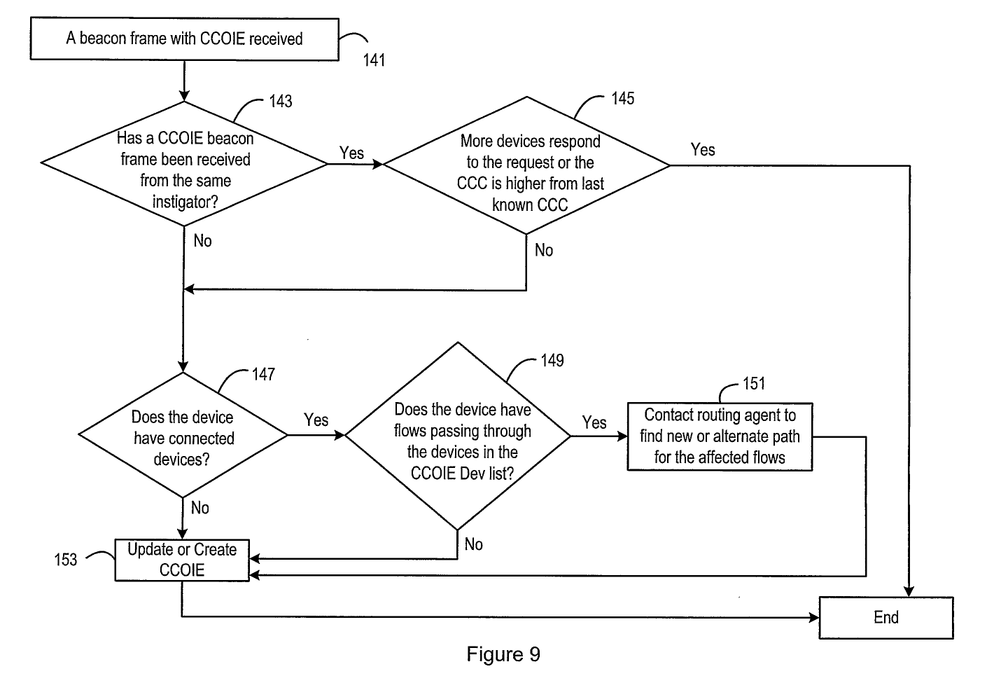

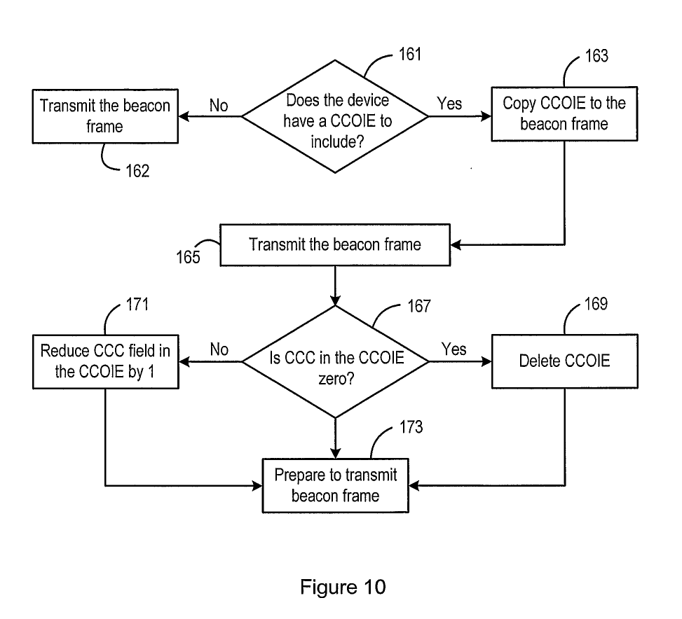

In the case of relay devices, the Beacon frames received are processed according to the method shown in FIG. 9 below, while the transmission of subsequent Beacon frames from the relay device to other relay devices or connected devices is carried out according to the method shown in FIG. 10. When a relay device receives a Beacon frame with a CCOIE, it replicates the CCOIE in its own Beacon frame (having decremented the CCC by 1 in accordance with the method in FIG. 7). Each propagated CCOIE has the value of its CCC field decremented by 1 during each subsequent superframe until the value of CCC is 0.

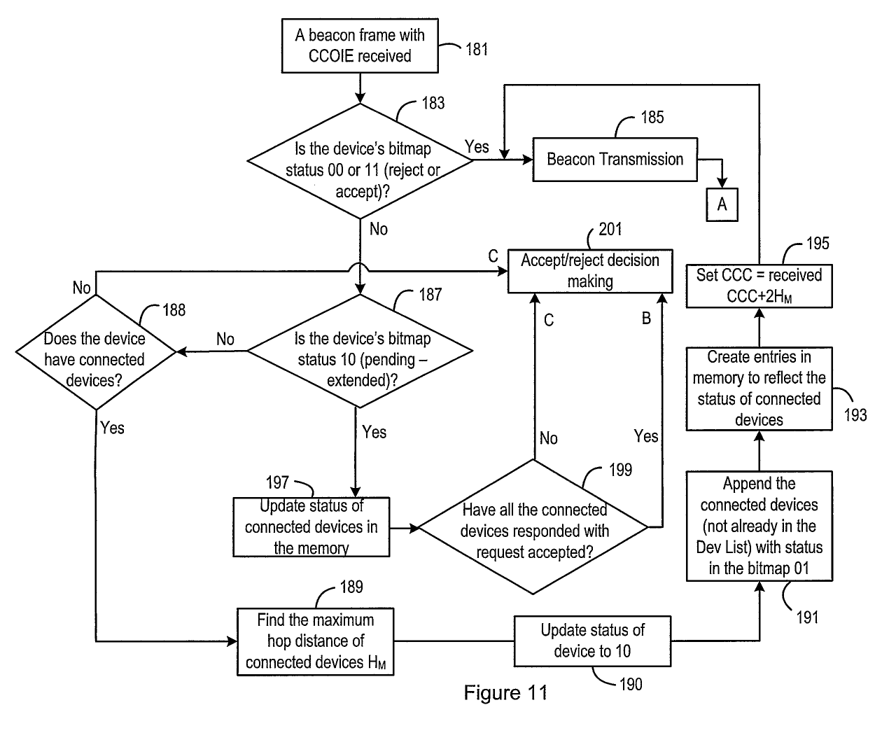

Connected devices process the received Beacon frames having a CCOIE according to the method shown in FIG. 11 below. A connected device is aware that it is classified as such a device because it will be listed as one of the connected devices in the CCOIE and this information will also have been stored in the routing layer. At this stage, connected devices are further divided into devices having respective connected devices (that are not connected devices of the channel switching instigator and are therefore not included in the connected device list of the CCOIE), and connected devices that do not have respective connected devices.

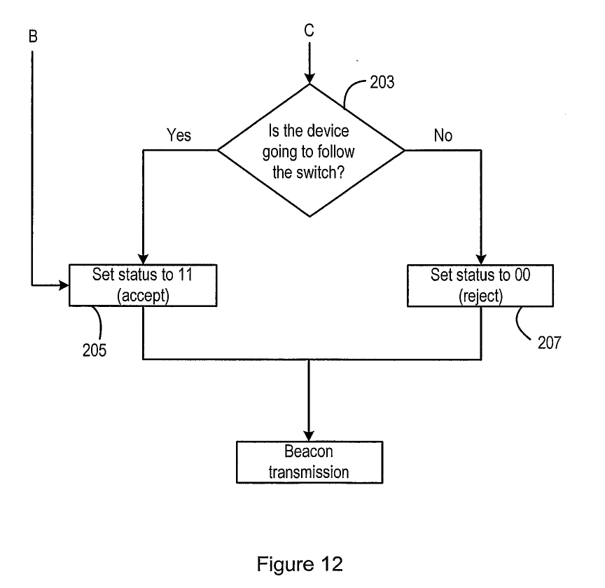

In the former case, the connected device extends the CCC appropriately to allow propagation of the intention to switch channels to its own connected devices, and to allow time for their response to come back. Thus, when the device responds to the channel switching instigator, it indicates its status as “pending-extended”. If the connected device does not have any respective connected devices, it can accept or reject the channel switching request and indicate this in the response to the channel switching instigator (see FIG. 12 below).

This procedure continues until all the devices respond with a status field accept/reject or until there is insufficient space in the CCOIE (which depends on the number of IEs transmitted during the Beacon period). In the latter case the device has to follow a decision making procedure to decide on whether to change channel or not.

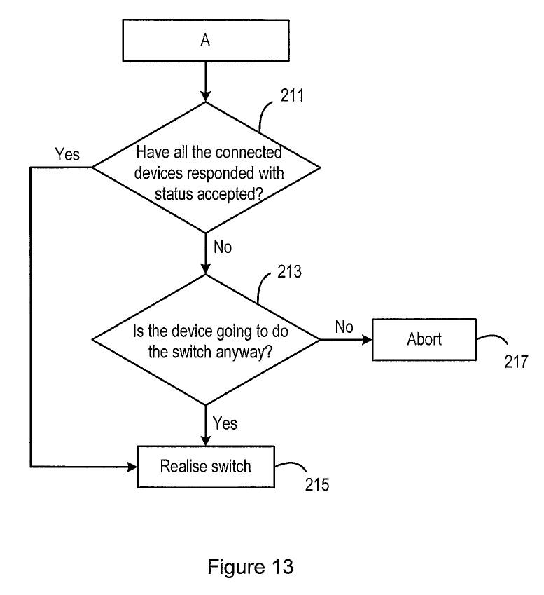

As described above, the channel switching advertisement procedure ends if the CCC of the instigator's CCOIE reaches zero, or when all the connected devices respond to the instigator with a channel switch accept or channel switch reject, whichever occurs earlier. At this point, the channel switching instigator decides whether the channel switch will be carried out or not. FIG. 13 illustrates a procedure for deciding whether to switch the channel.

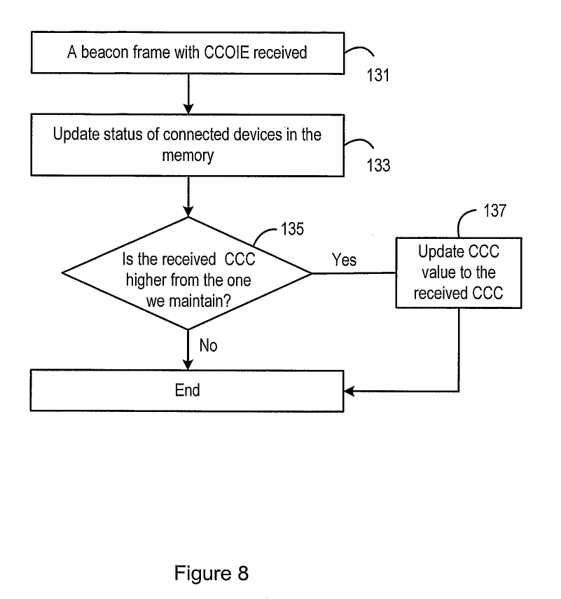

As indicated above, FIG. 8 shows a method performed by the channel switching instigator in response to receiving a Beacon frame with a CCOIE element. In step 131, the Beacon frame with the CCOIE is received. In step 133, the channel switching instigator updates the status of connected devices stored in its memory in response to the information contained in the CC Info Bitmap of the CCOIE. In step 135, it is determined whether the value of the CCC field in the received CCOIE is higher than the value maintained by the channel switching instigator. If the value of the received CCC is higher than the value maintained by the channel switching instigator, the value maintained by the channel switching instigator is updated to the received value (step 137), otherwise, the value of CCC maintained by the channel switching instigator is unchanged.

It will be appreciated that it is possible for a channel switching instigator to receive a CCOIE relating to a different channel switching request from another instigator device. However, only one channel switching request is allowed to proceed at a time, so, in this case, the later channel switching instigator cancels its channel switching request.

FIG. 9 shows the method performed by a relay device after a Beacon frame with a CCOIE is received. In step 141, the Beacon frame with the CCOIE is received by the relay device. The Beacon frame could be received from the channel switching instigator or from another intermediate relay device. In step 143, it is determined whether a Beacon frame with a CCOIE has previously been received from the same channel switching instigator. If a CCOIE has previously been received, the method passes to step 145 in which it is determined whether there are more devices that need to respond to the channel switch request or whether the value of the CCC field is higher than the last known value. If the answer to either of these is yes, the method ends.

If the answer to either of step 143 or step 145 is no, the method passes to step 147 in which it is determined whether the relay device has connected devices.

If the relay device does have connected devices, the method passes to step 149 in which it is determined whether the relay device has flows passing through the devices listed in the CCOIE as connected devices of the channel switching instigator. This means that the relay device is checking whether any connected devices are also relay devices for flows originating from, or terminating at, the relay device. The relay device performs this by contacting the routing layer, but only if its own traffic flows go through a device that is listed in the received CCOIE. Otherwise, the relay device will not be involved in the channel switching.

If the relay device does have traffic flows passing through a device or devices listed in the received CCOIE, the method passes to step 151 in which a routing agent is contacted in order to find a new or alternate path for the affected flows.

If the answer to the determinations in either of steps 147 or 149 is no, or after performing step 151, the method passes to step 153 in which the relay device creates a CCOIE or updates the received CCOIE with a new CCC value (determined in accordance with the method shown in FIG. 7). The method then ends.

FIG. 10 shows the method performed by a relay device in transmitting a Beacon frame after receiving a CCOIE from the channel switching instigator. In step 161, it is determined whether the relay device has a CCOIE to include in its Beacon frame. If there is no CCOIE to include, the beacon frame is transmitted in step 162. If there is a CCOIE to include, the CCOIE is copied into the appropriate place in the Beacon frame of the relay device (step 163).

After step 163 the method passes to step 165 in which the Beacon frame is transmitted.

After step 165, the device prepares for the transmission of a beacon frame in the next superframe. Specifically, the method passes to step 167 in which it is determined if the CCC field in the CCOIE has a value of 0. If the CCC field is 0, the CCOIE is deleted from the memory of the relay device (step 169). If the CCC field is non-zero, the value of CCC stored in the memory of the relay device is reduced by 1 (step 171).

After step 169 or 171, the method passes to step 173 in which the relay device prepares to transmit the Beacon frame.

FIG. 11 shows the steps performed by a connected device (referred to below for clarity as “first connected device”) after receiving a Beacon frame with a CCOIE. In step 181, the Beacon frame with CCOIE is received. In step 183, it is determined whether the status of the first connected device has already been decided from the CC Info Bitmap in the CCOIE (i.e. is the status of the device reject or accept?). If the status of the first connected device has been decided, the method passes to step 185 in which the first connected device transmits a Beacon frame.

Step 185 corresponds to step 113 in FIG. 6, and thus corresponds to the method shown in FIG. 7.

If the status of the first connected device has not been decided, the method passes to step 187 in which it is determined whether the status of the first connected device is “10” meaning that the request is pending but extended. The first connected device determines this by examining the relevant part of the CCOIE, and stores the status in an internal memory. If the status of the first connected device is not “pending but extended” (i.e. the status is merely pending—01), the method passes to step 188 in which it is determined whether the first connected device has any connected devices not listed in the device list. If the first connected device does not have any connected devices, the method passes to step 201 in which it is determined whether to accept or reject the channel change request.

If the first connected device does have connected devices, the method then passes to step 189 in which the maximum hop distance (H_{M}) of devices connected to the first connected device is determined. As above, this information is provided by the routing layer, which is the layer above the MAC protocol.

After step 189, the method passes to step 190 in which the first connected device updates its status to “10” to indicate that it is awaiting responses from its connected devices. Then, the method passes to step 191 in which the first connected device appends the identities of the devices to which it is connected to the device list in the CCOIE, if those devices are not already in that list. Each of the devices connected to the first connected device are given a status of 01 in the CC Info Bitmap (i.e. the channel switch request for those devices is pending).

In step 193, the first connected device creates corresponding status entries in an internal memory for each of the devices connected to the first connected device. In step 195, the value of the Channel Change Countdown field is set to the value of CCC in the received CCOIE plus 2*H_{M}. The method then passes to step 185 in which the first connected device transmits the new CCOIE in its Beacon frame.

If the status of the first connected device is determined to be pending but extended “10” in step 187, the method passes to step 197 in which the internally stored statuses of devices connected to the first connected device are updated based on the CC Info Bitmap received in the CCOIE. In step 199, it is determined whether all of the devices connected to the first connected device have responded with a channel change request accept.

The method then passes to step 201 in which the device determines whether it will accept or reject the channel switch request contained in the CCOIE, based on the output of step 199. The output of the accept or reject decision making step provides a status for the first connected device to include in the CCOIE transmitted in its Beacon frame (step 185).

FIG. 12 illustrates the accept/reject decision making of step 201 in more detail. If the output of step 199 is no (i.e. all the connected devices have not responded with a channel switch request accept—including receiving one or more “channel switch request rejects” and/or failing to receive a response from a particular device, whether positive or negative), it is determined whether the first connected device is going to follow the channel switch anyway (step 203). The criteria used by a device to determine whether it will follow the switch can be set by the network operator, and can be based on a quality of service measured on the affected traffic flow and/or on the location of the device relative to the channel switching instigator.

If the first connected device decides to follow the switch anyway, it sets its status in the CC Info Bitmap to 11, indicating that it is accepting the channel switch request (step 205). If the first connected device decides not to follow the channel switch, it sets its status in the CC Info Bitmap to 00, indicating that it is rejecting the channel switch request (step 207).

If the output of step 199 is yes (i.e. all the connected devices have responded with a channel switch request accept), the method passes to step 205 in which the first connected device sets its status in the CC Info Bitmap to 11, indicating that it is accepting the channel switch request.

In either case, the method passes to step 185 in which a Beacon is transmitted that indicates the decision of the device.

When the Channel Change Countdown (CCC) in the CCOIE reaches 0, the channel switching instigator determines whether to switch channels, as shown in FIG. 13. The method starts at A, and the channel switching instigator determines whether all of its connected devices have accepted the channel switch request (step 211). If not, the method passes to step 213 in which the channel switching instigator determines whether it will carry out the channel switch anyway. The criteria used to determine whether to switch anyway can be set by the network operator or device manufacturer as desired.

If the result of steps 211 or 213 is positive (i.e. all connected devices have accepted the channel switch request or the channel switching instigator is going to carry out the channel switch anyway), the method moves to step 215 in which the channel switch is realised.

If the channel switching instigator determines, in step 213, that it will not carry out the switch, the method moves to step 217 in which the channel switch is aborted.

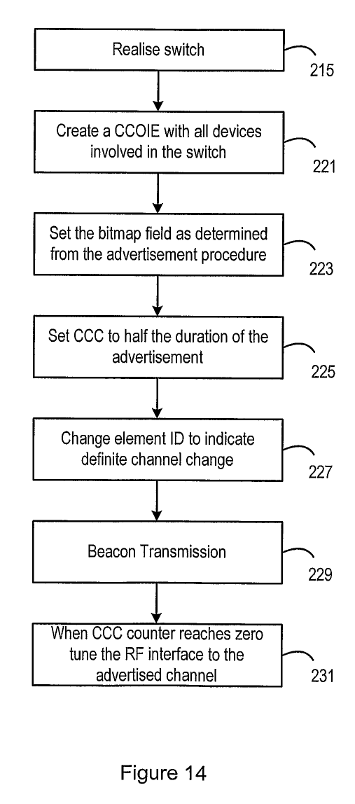

FIG. 14 shows the steps carried out by the channel switching instigator if it decides to realise the channel switch (step 215). The channel switching instigator creates a new CCOIE including all the devices involved in the channel switch with their appropriate switch status (steps 221 and 223) and sets CCC equal to half the advertisement duration (which includes any extensions used during the advertisement procedure) (step 225). In step 227, the Element ID is set to indicate that the CCOIE relates to a definite channel change rather than a provisional channel change request.

The generated CCOIE is then transmitted by the channel switching instigator in its Beacon frame (step 229, which corresponds to the method set out in FIG. 7). The definite change indicated in the CCOIE will then be provided to all the devices in the traffic flow paths, and to the devices that accepted the channel switch request. Devices receiving the CCOIE with the modified Element ID replicate the information element into their Beacon frames with the value of the CCC field decreased by one unit.

When the value of the CCC field reaches 0, all of the relevant devices (i.e. the channel switching instigator, any relay devices and connected devices) tune their RF interface to the channel indicated in the Channel ID field of the CCOIE (step 231) and the channel switching procedure is completed.

Thus, there is provided a method for use in a communication network for coordinating a channel switch operation across single and multiple “hops”. The method is particularly suited to an ultra wideband environment in accordance with the ECMA 368 standard MAC. As described, the device instigating the channel switch acts as a co-ordinator of the procedure, and co-ordinates the channel switch action via information elements included in Beacon frames. By using Beacon frames, the overhead carried by the network is significantly reduced in comparison to dedicated channel switching signalling mechanisms. In addition, by advertising the intention of the channel switch instigator to switch channels, there is minimal network disruption (including lower levels of packet loss and delay) while maintaining maximum connectivity.

Importantly, the proposed method introduces predictability and control into the channel change process, as the channel switching instigator and connected devices will have knowledge about when the channel change can or will happen. This is not possible with prior art implementations.

From the perspective of a user of the network, the channel switch operation (along with the decision process relating to the selection of the channel to switch to) is transparent and requires minimal extra resources.

The described algorithm is compatible with conventional devices that do not support the algorithm and such devices can co-exist and channel switch in the traditional manner, without compromising the functionality of devices according to the invention.

1. A method of changing channels in a communication network, there being a traffic flow on a first channel between first and second devices in the network, the method comprising:
forming an information element, the information element including a channel change request from the first device; and
transmitting the information element from the first device to the second device in a Beacon frame.

2. A method as claimed in claim 1, wherein the network comprises a plurality of traffic flows between pairs of devices, and the step of transmitting the information element comprises transmitting the information element from the first device to the other devices in the network.

3. A method as claimed in claim 1, the method further comprising the step of:
on receipt of the information element, processing the information element to determine whether to accept or to reject the channel change request from the first device.

4. A method as claimed in claim 3, wherein, after processing the information element to determine whether to accept or reject the channel change request from the first device, the method further comprises the step of:
forming a respective information element using the received information element, the respective information element including a status field indicating whether the device has accepted or rejected the channel change request; and
transmitting the respective information element in a subsequent Beacon frame.

5. A method as claimed in claim 3, wherein, the step of processing the information element by a device comprises determining whether said device has a traffic flow with any devices other than the first device.

6. A method as claimed in claim 5, wherein if said device does have a traffic flow with another device or devices, forming a respective information element from the received information element, the respective information element including the channel change request from the first device; and
transmitting the respective information element from said device in a subsequent Beacon frame.

7. A method as claimed in claim 6, wherein the received information element comprises a countdown element, and the step of forming the respective information element comprises including the countdown component from the received information element increased by a predetermined amount.

8. A method as claimed in claim 6, wherein the received information element comprises a list of devices having traffic flows with the first device, and the step of forming comprises including the list of devices in the respective information element and updating the list to include said another device or devices.

9. A method as claimed in claim 8, wherein the list of devices in the information element includes an associated status for each device, the status indicating whether the listed device has accepted or rejected the channel change request, or whether the decision of the device is still pending.

10. A method as claimed in claim 1, wherein the traffic flow between the first and second devices comprises at least one third device disposed between the first and second devices that serves as an intermediate relay device for the traffic flow, and wherein:
on receipt of the information element by the third device, the third device forms a respective information element from the received information element, the respective information element including the channel change request from the first device; and
transmitting the respective information element from the third device to the second device in a subsequent Beacon frame.

11. A method as claimed in claim 1, wherein received information element comprises a countdown element, and the step of forming the respective information element comprises including the countdown component from the received information element decreased by one.

12. A method as claimed in claim 10, wherein the received information element comprises a list of devices having traffic flows with the first device, and the step of forming comprises including the list of devices in the respective information element.

13. A method as claimed in claim 12, wherein the list of devices in the information element includes an associated status for each device, the status indicating whether the listed device has accepted or rejected the channel change request, or whether the decision of the device is still pending.

14. A method as claimed in claim 1, wherein the information element includes a field indicating the identity of the channel to which the first device would like to switch.

15. A method as claimed in claim 1, wherein after a determined interval, the first device decides whether to carry out the channel switch.

16. A method as claimed in claim 15, further comprising the step of forming an information element, the information element including a channel change instruction from the first device; and
transmitting the information element from the first device to the other devices involved in the channel switch.

17. A method as claimed in claim 16, wherein the information element includes switch status information relating to the other devices involved in the channel switch.

18. A method as claimed in claim 16, wherein the information element contains a countdown element, the countdown element confirming when the channel switch will occur.

19. A first device for use in a communication network, the first device being adapted to maintain a traffic flow on a first channel with one or more other devices in the network, the first device comprising:
means for forming an information element, the information element including a channel change request; and
means for transmitting the information element from the first device to the one or more other devices in a Beacon frame.

20. A first device as claimed in claim 19, the first device further comprising means, responsive to receiving an information element from an instigator device, for processing the information element to determine whether to accept or to reject the channel change request from the instigator device.

21. A first device as claimed in claim 20, wherein the means for forming an information element is further adapted to form an information element using the received information element, the information element including a status field indicating whether the first device has accepted or rejected the channel change request; and the means for transmitting is further adapted to transmit the information element in a subsequent Beacon frame.

22. A first device as claimed in claim 21, wherein the means for processing the information element is adapted to determine whether said first device has a traffic flow with any devices other than said instigator device.

23. A first device as claimed in claim 22, wherein if said first device has a traffic flow or flows with any devices other than said instigator device, the means for forming the information element is adapted to form an information element from the received information element, the information element including the channel change request from said instigator device; and the means for transmitting is adapted to transmit the respective information element from said first device in a subsequent Beacon frame.

24. A first device as claimed in claim 23, wherein the received information element comprises a countdown element, and the means for forming an information element is further adapted to include the countdown component from the received information element in the formed information element increased by a predetermined amount.

25. A first device as claimed in claim 23, wherein the received information element comprises a list of devices having traffic flows with said instigator device, and the means for forming the information element is adapted to include the list of devices in the information element and to update the list to include any devices that the first device has a traffic flow or flows with.

26. A first device as claimed in claim 25, wherein the list of devices in the information element includes a status associated with each device in the list, the status indicating whether the listed device has accepted or rejected the channel change request, or whether the decision of the device is still pending.

27. A first device as claimed in claim 19, wherein the first device is a relay device for a traffic flow between the instigator device and a second device, and wherein:
on receipt of the information element from the instigator device, the means for forming an information element is adapted to form an information element from the received information element, the information element including the channel change request from the instigator device; and
the means for transmitting is adapted to transmit the information element to the second device in a subsequent Beacon frame.

28. A first device as claimed in claim 19, wherein received information element comprises a countdown element, and the means for forming an information element is adapted to form an information element that comprises the countdown component from the received information element decreased by one.

29. A first device as claimed in claim 27, wherein the received information element comprises a list of devices having traffic flows with the instigator device, and the means for forming an information element is adapted to include the list of devices in the information element.

30. A first device as claimed in claim 29, wherein the list of devices in the information element includes an associated status for each device, the status indicating whether the listed device has accepted or rejected the channel change request, or whether the decision of the device is still pending.

31. A first device as claimed in claim 19, wherein the information element includes a field indicating the identity of the channel to which the instigator device would like to switch.

32. A first device as claimed in claim 31, the means for forming an information element being further adapted to form an information element that includes a channel change instruction; and
the means for transmitting being further adapted to transmit the information element to the one or more other devices involved in the channel switch.

33. A first device as claimed in claim 32, wherein the information element includes switch status information relating to the other devices involved in the channel switch.

34. A first device as claimed in claim 32, wherein the formed information element contains a countdown element, the countdown element confirming when the channel switch will occur.
